(19) United States
(12) Patent Application Publication
(10) Pub. No.: US 2023/0356341 A1
(43) Pub. Date: Nov. 9, 2023

(54) Machine Tool and Detection System

(71) Applicant: Robert Bosch GmbH, Stuttgart (DE)

(72) Inventor: Dieter Volpert, Laudenbach (DE)

(21) Appl. No.: 18/246,097

(22) PCT Filed: Sep. 9, 2021
(86) PCT No.: PCT/EP2021/074746

§ 371 Date: Mar. 21, 2023

(30) Foreign Application Priority Data
Sep. 22, 2020 (DE) 10 2020 211 803.5

(51) Int. Cl. B23Q 11/00; F16P 3/14; B23D 59/00

(52) U.S. Cl. CPC B23Q 11/0082; F16P 3/148; B23Q 11/0092; B23D 59/001

(57) ABSTRACT

The disclosure relates to a machine tool having a driveable tool and having a detection system for detecting contact between the tool and a user. The detection system has an excitation device for applying an excitation voltage signal to the tool, a current sensor for generating a current sensor signal that represents an electric current consumed by the tool, and a processing device for processing the current sensor signal in order to detect contact between the tool and the user. The processing device has an analog-to-digital converter and further devices arranged downstream of the analog-to-digital converter, comprising an IQ demodulator, a filter device and an evaluation device. The current sensor signal is able to be digitized using the analog-to-digital converter and processed in digital form using the further devices. The disclosure furthermore relates to a detection system for a machine tool.

The present invention relates to a machine tool having a driveable tool and having a detection system for detecting contact between the tool and a user. The invention further relates to a corresponding detection system for a machine tool.

### PRIOR ART

Machine tools have a driveable tool for manufacturing or machining a workpiece. One example is a sawing machine having a tool designed as a saw blade. In the development of machine tools, their safety is becoming increasingly important. Here, the occurrence of injuries in users, for example the occurrence of cut wounds or loss of body parts, is to be avoided, or the severity thereof is at least to be reduced. A high degree of safety can be achieved by the use of a detection system, by which contact between a tool and a user can be detected. Known stationary sawing machines such as, for example, table circular saws can be equipped with such a system. Using the system, in the case of detected contact a safety measure such as, for example, rapid moving away or braking of the saw blade can be triggered.

In a known embodiment, the detection system comprises an excitation device for applying an excitation voltage signal to the saw blade and a current sensor for generating a current sensor signal that represents an electric current consumed by the tool. For processing the current sensor signal, the detection system comprises a plurality of separate components, i.e. an IQ demodulator arranged downstream of the current sensor and in the form of an integrated circuit or semiconductor chip, a filter arranged downstream of the IQ demodulator and formed from discrete hardware components, and a microcontroller arranged downstream of the filter. Analog signal processing takes place using the IQ demodulator and the filter. The microcontroller has an analog-to-digital converter to digitize the signals present after the filter. The digital signals are subsequently processed using the microcontroller in order to detect contact between the saw blade and the user.

Due to the use of discrete components (IQ demodulator, filters, microcontrollers), the known detection system occupies a relatively large space. As a result, the system can be used in a stationary sawing machine, but is rather unsuitable for a manually guided sawing machine due to the spatial limitations. Another aspect is the reaction time, which comprises the processing time required by the detection system for detecting contact and the time for carrying out a safety measure. In a stationary sawing machine, the safety measure can consist of rapid moving away of the saw blade. This procedure is not available for a manually guided sawing machine. Here, only braking of the saw blade is possible. Hand-guided operation also limits the braking force applied for the braking. In the case of a hand-guided sawing machine, there are therefore greater requirements of a short processing time.

### DISCLOSURE OF THE INVENTION

The object of the present invention is to provide a machine tool having an improved detection system for detecting contact between a tool and a user, and an improved detection system for a machine tool.

This object is achieved by the features of the independent claims. Further advantageous embodiments of the invention are specified in the dependent claims.

According to one aspect of the invention, a machine tool is proposed having a driveable tool and a detection system for detecting contact between the tool and a user. The detection system has an excitation device for applying an excitation voltage signal to the tool, a current sensor for generating a current sensor signal that represents an electric current consumed by the tool, and a processing device for processing the current sensor signal in order to detect contact between the tool and the user. The processing device has an analog-to-digital converter and further devices arranged downstream of the analog-to-digital converter, including an IQ demodulator, a filter device, and an evaluation device. The current sensor signal can be digitized using the analog-to-digital converter and can be processed in digital form using the further devices.

In the detection system of the proposed machine tool, an analog-to-digital conversion, and thus sampling of the analog current sensor signal, is not carried out by the analog-to-digital converter only at the end, but already at the beginning or, relatively, at the start of the signal chain that processes the current sensor signal. The signal processing using the further devices of the processing device that are arranged downstream of the analog-to-digital converter, such as the IQ demodulator, the filter device and the evaluation device, takes place in the digital domain. In other words, the further devices are digital or digitally operating components. This makes it possible to achieve a short processing time or detection time for detecting contact between the tool and the user. The processing can also be subject to smaller external disturbing influences, and can thereby be relatively reliable. In this way, a high degree of functional safety of the machine tool can be made possible. The processing device and thus the detection system can in addition be implemented with a compact and space-saving design. In this way, the range of application can be expanded with respect to the detection system. For the machine tool, in this respect not only an embodiment in the form of a stationary machine tool, but also in the form of a hand-guided machine tool, is conceivable.

In the following, further possible embodiments and details that may be considered for the machine tool and the detection system are described. In addition, reference is made to the possibility of combining several of the described embodiments with one another. Furthermore, details mentioned in relation to one embodiment can also be used in another embodiment.

During operation, the tool, which can have an electrically conductive or metallic material, can be supplied with the excitation voltage signal by the excitation device. The current flowing away from the tool can be acquired by the current sensor, and the current sensor signal generated by the current sensor and representing the current consumption of the tool can be processed using the processing device. These processes can take place continuously during operation of the machine tool or the detection system. If there is no contact between the tool and the user, the current drawn by the tool and thus the current sensor signal can be relatively small or near zero. Contacting of the tool by the user can lead to a (significant) change of the current consumption of the tool and thus of the current sensor signal, which can be used in the detection system to detect the contact.

The tool of the machine tool can be driven by a drive device, which can comprise, for example, an electric motor. The tool can be used to machine a workpiece, for example, wood.

In a further embodiment, the machine tool is a sawing machine. For example, an embodiment as a stationary table circular saw or cross-cut saw, or as a hand-guided sawing machine, for example as a hand circular saw, is possible. Here, the driveable tool can be a saw blade.

In a further embodiment, the excitation device is designed to apply the excitation voltage signal to the tool by a capacitive coupling. The excitation voltage signal can be coupled capacitively to the tool. In this connection, the following embodiments can also be used.

In a further embodiment, the excitation device has a voltage generating device for generating the excitation voltage signal and an excitation electrode. The voltage generating device can have an oscillator and at least one voltage amplifier connected to the oscillator. The excitation electrode can be connected to the voltage generating device or a voltage amplifier thereof via a line. The excitation electrode can have an electrically conductive or metallic material. The excitation voltage signal generated by the voltage generation device can be capacitively coupled to the tool via the excitation electrode. The current sensor can be designed to generate the current sensor signal by acquiring an electric current flowing in the line.

The excitation electrode can be located in the region or near the tool in order to reliably capacitively couple the excitation voltage signal to the tool. In an embodiment of the tool as a saw blade, the excitation electrode can be plate-shaped or can be in the form of an excitation plate. The current sensor can be arranged on the line connecting the excitation electrode and the voltage generating device. Furthermore, the current sensor can be in the form of a current transformer.

In a further embodiment, the machine tool has a shield arranged in the region of the tool and the excitation electrode and electrically connected to the voltage generating device. The voltage generating device is designed to electrically drive the shield corresponding to the excitation electrode, or in other words, to apply the same electrical potential to the shield and to the excitation electrode. Using the shield, which can serve as a Faraday cage, the influence of interfering effects from the environment on the detection system can be reduced. The shield can be connected to the voltage generating device or a voltage amplifier thereof via a further line.

In a further embodiment, the machine tool has a reaction system for deactivating operation of the tool. The detection system can be designed to activate the reaction system in the event of detected contact between the tool and the user. The reaction system can comprise means for moving away or rapidly moving the tool away from the user. A pyrotechnic charge can be used here. The reaction system can additionally or alternatively have a braking device using which a movement of the tool can be braked or stopped. This can prevent (severe) injury to the user.

To activate the reaction system, a trigger signal can be generated by the detection system and transmitted to the reaction system. For this purpose, the processing device or its evaluation device can be designed to generate such a trigger signal for deactivating operation of the tool, and thus for activating the reaction system, on the basis of the signal processing.

The excitation voltage signal applied to the tool can be a time-varying or periodic voltage signal and thus an alternating voltage signal. The excitation voltage signal can be, for example, a sinusoidal signal.

In a further embodiment, the excitation voltage signal, which can be used as a carrier signal, has a frequency or carrier frequency of 1.25 MHz. As a result, contact between the tool and the user can be reliably detected by the detection system. Furthermore, such contact can be reliably distinguished from another contact event, for example contact between the tool and a workpiece.

In a further embodiment, the IQ demodulator is arranged downstream of the analog-to-digital converter, the filter device is arranged downstream of the IQ demodulator, and the evaluation device is arranged downstream of the filter device.

In a further embodiment, the machine tool has an analog pre-filter upstream of the analog-to-digital converter or the processing device. The pre-filter can be used to remove frequency components of the analog current sensor signal that are not required for signal processing or that interfere with it. This can promote fast and reliable execution of signal processing. The pre-filter can be a low-pass filter.

In a further embodiment, the analog-to-digital converter is designed to carry out the digitization of the current sensor signal by oversampling. Here, the sampling frequency can be freely selected. This can also result in low demands made on the pre-filter. The pre-filter can therefore be relatively simple in design, and in the form of an anti-aliasing filter, for example.

The sampling frequency can be a multiple, for example, four times the carrier frequency of the excitation voltage signal. With reference to the carrier frequency of 1.25 MHz mentioned above, the sampling frequency can thus be 5 MHz. This can simplify a subsequent demodulation of the digital current sensor signal carried out using the IQ demodulator.

The demodulation of the digital current sensor signal using the IQ demodulator can include converting the current sensor signal to a digital I signal (in-phase signal) and a digital Q signal (quadrature signal). The carrier signal can be removed during the demodulation. By forming the digital I signal and Q signal from the digital current sensor signal, the information content with respect to the signal processing can be improved. The I signal can correspond to the phase angle of the carrier signal or the excitation voltage signal, and the Q signal can be phase-shifted by ninety degrees thereto.

The IQ demodulator can have a numerically controlled oscillator and two mixers. Using the numerically controlled oscillator, two periodic oscillator inputs can be generated and, using the mixers, mixed with the digital current sensor signal to generate the digital I and Q signal. The oscillator signals can have the same frequency as the excitation voltage signal, i.e. the carrier frequency. The oscillator signals can also be phase-shifted by ninety degrees. Using the mixers, a down-mixing, i.e. a frequency conversion to a lower frequency, can take place. In this way, the carrier signal can be removed. By contrast, an item of useful information of interest or a useful signal that can be used to detect the contact between the tool and the user can be retained, and can thus be contained in the digital I and Q signal.

In a further embodiment, the IQ demodulator is designed to convert the digital current sensor signal into a digital I signal and a digital Q signal. The filter device is designed to filter the digital I signal and Q signal. The evaluation device is designed to process the filtered digital I signal and Q signal in order to detect contact between the tool and the user and, on the basis of the processing, to generate a trigger signal to deactivate operation of the tool. Using the trigger signal, a reaction system of the machine tool can be activated, as indicated above.

By filtering the digital I signal and Q signal, which can be done separately for the I signal and Q signal, unneeded or interfering frequency components of the I signal and Q signal can be removed. The useful information contained in the I signal and Q signal, in contrast, can pass through the filter device. As a result, fast and reliable execution of the signal processing can be further promoted.

The filter device can be in the form of a low-pass filter, whereby high-frequency components of the digital I signal and Q signal can be removed. Furthermore, the filter device can be designed to reduce the sampling rate and thus the data rate. This also proves to be favorable for rapid execution of the signal processing.

Reliable and efficient filtering of the I signal and Q signal can be achieved according to the following embodiment. Here, the filter device has a cascaded integrator comb filter (CIC) and a compensation filter arranged downstream of the CIC filter. The compensation filter can be a FIR filter (finite impulse response filter). The above-mentioned reduction in the sampling rate can be achieved using the CIC filter. The compensation filter can be used to compensate a (sharp) drop in the passband of the CIC filter. With reference to the separate filtering of the I signal and Q signal, the filter device for the I signal and the Q signal can in each case have a CIC Filter and a downstream compensating filter.

The evaluation device of the processing device of the detection system can be designed to carry out the signal processing using a predetermined algorithm. The algorithm can include an adaptive threshold process. In a further embodiment implemented in this sense, the evaluation device is designed to calculate an instantaneous energy value of the current consumption of the tool and an adaptive threshold value, and to generate a trigger signal for deactivating operation of the tool on the basis of a comparison between the instantaneous energy value and the adaptive threshold value. Here, the presence of contact between the tool and the user can be assumed when the instantaneous energy value exceeds the adaptive threshold value. If this condition is present, the trigger signal can be generated.

The instantaneous energy value and the adaptive threshold value can be calculated on the basis of the filtered digital I signal and Q signal, or samples thereof. For temporally successive sampling values, a separate instantaneous energy value and an associated adaptive threshold value can be calculated in each case. Using the adaptive threshold value, a temporal course or a temporal development of the I and Q signal preceding the relevant instantaneous energy value considered can be taken into account. In this way, the influence of individual sampled values of the I and Q signals, which may deviate (considerably) from other or neighboring sampled values, for example due to interference from the environment, can be suppressed. As a result, a high degree of robustness of the detection system and a high degree of reliability with respect to the detection of contact between the tool and the user can be achieved. Faulty generation of the trigger signal, even though there is no contact between the tool and the user (false positive event), can therefore be suppressed.

The instantaneous energy value can be calculated (in each case) by summing squared sampled values of the I and Q signal. The calculation of the associated adaptive threshold value can include calculating a mean value of instantaneous energy values. The mean value can refer to a block of samples of the I and Q signal. The number of samples of the block can be sixteen, making it possible to efficiently and quickly calculate, and thereby detect, contact between the tool and the user. The sampled values of the block can temporally precede the relevant instantaneous energy value considered (or its sampled values).

Within the framework of calculating the adaptive threshold value, in addition at least one further parameter can be calculated and summed with the aforementioned mean value of instantaneous energy values to form the adaptive threshold value. This can include a specified bias value. Another parameter is an output value taking into account the occurrence of peak values of the instantaneous energy.

The evaluation device can further be designed to calculate a signal-to-noise ratio, and to additionally carry out the generation of the trigger signal on the basis of a comparison of the calculated signal-to-noise ratio with a specified limit value. As a result, faulty generation of the trigger signal as a result of a (strong) noise signal can be suppressed. In this embodiment, the above-described exceeding of the adaptive threshold by the instantaneous energy value can be the primary condition, and the generation of the trigger signal can be subject to the additional secondary condition that the calculated signal-to-noise ratio exceeds the threshold.

Calculating the signal-to-noise ratio, which can also be based on the filtered digital I signal and Q signal, can include calculating a mean and standard deviation of samples of the filtered I signal and Q signal. This can be done based on calculating local mean values and local variances related to multiple blocks of samples of the I and Q signal. The number of samples of a block can be sixteen here as well, to enable efficient and fast calculation. Further, a current block of samples comprising samples causing the primary condition to be satisfied, multiple previous blocks of temporally preceding samples, and a subsequent block of temporally succeeding samples may also be taken into account.

In a further embodiment, the evaluation device includes an artificial neural network. The artificial neural network can be designed to process the filtered digital I signal and Q signal to generate a trigger signal based thereon for deactivating operation of the tool. For this purpose, the artificial neural network can have been trained in a suitable manner. The training can include supervised learning, reinforcement learning, or unsupervised learning.

The training of the artificial neural network can be done using samples of the I and Q signals with correct trigger signals (true positive events) and with incorrect trigger signals (false positive events). The correct trigger signals, together with associated samples of the I and Q signal, can relate to the presence of contact to be detected between the tool and the user, whereas in the case of the incorrect trigger signals and associated samples there is no such contact. As a result of the training, the trigger signal can be generated by the evaluation device only in the event of contact actually taking place between the tool and the user, and to this extent a distinction can be made between a true positive and a false positive event.

The artificial neural network can comprise a plurality of interconnected neurons or nodes. The artificial neural network can further comprise an input layer, at least one hidden layer and an output layer. The input layer and the hidden layer(s) may have multiple nodes. The input layer, or its nodes, can receive the filtered digital I signal and Q signal. The output layer can have an output node via which the trigger signal can be outputted. Furthermore, the artificial neural network can be designed as a binary artificial neural network.

The processing device of the detection system can be in the form of an integrated circuit, i.e. in the form of a semiconductor chip or signal processing chip. Depending on the design of the processing device, the devices arranged downstream of the analog-to-digital converter and their components, such as the IQ demodulator, the filter device and the evaluation device, can be in the form of hardware or software components or modules. The processing device can optionally also comprise a plurality of semiconductor chips.

In another embodiment, which can be used in this connection, the processing device has at least one FPGA (field programmable gate array), at least one microcontroller and/or at least one CPU (central processing unit). Where, as indicated above, the processing device is in the form of a single semiconductor chip, an embodiment in the form of a single FPGA or in the form of a single microcontroller or CPU can be considered for the processing device. Given an embodiment as an FPGA, the devices arranged downstream of the analog-to-digital converter can be in the form of programmed hardware or logic blocks, and, in an embodiment as a microcontroller or CPU, in the form of software modules.

The FPGA embodiment offers the possibility of flexibly subsequently redesigning the functionality of the processing device through reprogramming. This can be considered, for example, with respect to the filter device, which in this respect can be a reprogrammable filter device.

An FPGA is also suitable, or can be designed, for performing parallel signal processing. This is also conceivable with respect to the filter device. Using the processing device in the form of an FPGA, a short detection time for detecting contact between the tool and the user can therefore be further promoted.

In a further embodiment, the processing device is designed to process the digital current sensor signal via a first and a second processing channel. The processing device has an IQ demodulator, a filter device and an evaluation device with respect to each of the first and second processing channels. The processing device further comprises at least one comparison device to which processing data accumulated in the first and second processing channels can be transmitted. The comparison device is designed to compare the processing data of the first and second processing channels and, on the basis of the comparison, to generate a switch-off signal for switching off operation of the tool and/or a warning signal.

According to the above-described embodiments, in each of the processing channels the filter device can be arranged downstream of the IQ demodulator, and the evaluation device can be arranged downstream of the filter device. The IQ demodulators, the filter devices, the evaluation devices and the at least one comparison device are again digitally operating components. The processing device can further include a data distributor arranged downstream of the analog-to-digital converter and upstream of the IQ demodulators, which distributor can be used to split the digital current sensor signal and distribute it to the first and second processing channels. The data distributor is also a digitally operating component.

In the above embodiment, a dual signal processing is performed in the first and second processing channels. It is further provided to compare processing data obtained in the two processing channels using the comparison device. The transmission of the processing data to the comparison device and the comparison thereof using the comparison device can take place continuously during the operation of the machine tool or of the detection system. The processing data can be generated by the evaluation devices of the two processing channels. If a difference between the processing data is determined by the comparison device, which indicates a faulty functioning of at least one processing channel, the comparison device can generate a switch-off signal and/or a warning signal. In this respect, a self-test or continuous self-test of the detection system can be achieved by the comparison. The switch-off signal can be transmitted, for example, to a drive device driving the tool, or to a control device thereof, in order to switch off the operation of the tool and to put the machine tool into a safe state. The warning signal can, for example, be reproduced acoustically or visually, or can be used to control corresponding devices such as a loudspeaker or a display device of the machine tool. The two-channel design of the processing device consequently enables a high degree of functional safety and reliability of the detection system and of the machine tool.

In a further embodiment, the processing data transmitted to the comparison device for the comparison are instantaneous energy values of the power consumption of the tool, calculated by the evaluation devices of the first and second processing channels. In this connection, the evaluation devices of the first and second processing channels can be designed, according to the above-described embodiment, to carry out a predetermined algorithm within the framework of the signal processing, and to calculate, inter alia, an instantaneous energy value of the current consumption and an adaptive threshold value.

It is also possible for the evaluation devices of the first and second processing channels to each have an artificial neural network. Here, the processing data transmitted for the comparison can, for example, be data output by one or more nodes of the relevant network, for example from a hidden layer.

With regard to the two-channel embodiment of the processing device, further embodiments and details explained above relating to the devices of the first and second processing channels can be used. In this sense, according to a further embodiment, it is provided that the IQ demodulators of the first and second processing channels are designed to convert the digital current sensor signal into a digital I signal and a digital Q signal, that the filter devices of the first and second processing channels are designed to filter the digital I signal and Q signal, and that the evaluation devices of the first and second processing channels are designed to process the filtered digital I signal and Q signal in order to detect contact between the tool and the user and, on the basis of the processing, to generate a trigger signal for deactivating operation of the tool.

In a further embodiment, the trigger signals generated by the evaluation devices of the first and second processing channels are transmittable to the comparison device. The comparison device is designed to generate its own trigger signal for deactivating operation of the tool, provided that a trigger signal is transmitted to the comparison device by at least one of the evaluation devices of the first and second processing channels. In this way, the operation of the tool can be reliably deactivated if the presence of contact between the tool and the user is detected on the basis of the signal processing in at least one of the two processing channels.

Also, as described above the two-channel processing device can be in the form of a single semiconductor chip, and thus for example in the form of an FPGA or in the form of a microcontroller or CPU. With reference to an FPGA design, a structure consisting of separate isolated areas according to the isolation design flow (IDF) methodology is also conceivable, whereby malfunctions can be suppressed with a high degree of reliability. Alternatively, a structure consisting of a plurality of semiconductor chips can be considered. Here, the analog-to-digital converter can be in the form of a separate semiconductor chip, and the first and second processing channels can each be in the form of a separate semiconductor chip (FPGA or microcontroller or CPU). The semiconductor chips in question may each have an IQ demodulator, a filter device, an evaluation device and a comparison device. Here, processing data accumulated in the first and second processing channels may be transmitted to both comparison devices for comparison, and the comparison devices may be designed to generate a switch-off signal and/or a warning signal in response to the comparison, as indicated above.

According to a further aspect of the invention, a detection system is proposed for a machine tool having a driveable tool, for detecting contact between the tool and a user. The detection system has an excitation device for applying an excitation voltage signal to the tool, a current sensor for generating a current sensor signal that represents an electric current consumed by the tool, and a processing device for processing the current sensor signal in order to detect contact between the tool and the user. The processing device has an analog-to-digital converter and further devices arranged downstream of the analog-to-digital converter, including an IQ demodulator, a filter device, and an evaluation device. The current sensor signal can be digitized using the analog-to-digital converter and can be processed in digital form using the further devices.

The same embodiments, details and advantages as already explained above can be used for the detection system. For example, a short detection time for detecting contact between the tool and the user can be achieved, and the signal processing can be exposed to low external interference.

The advantageous embodiments and developments of the invention explained above and/or indicated in the dependent claims can be used individually or in any combination with one another, except for example in cases of clear dependencies or incompatible alternatives.

The invention is explained in more detail below with reference to the schematic figures. In the drawings:

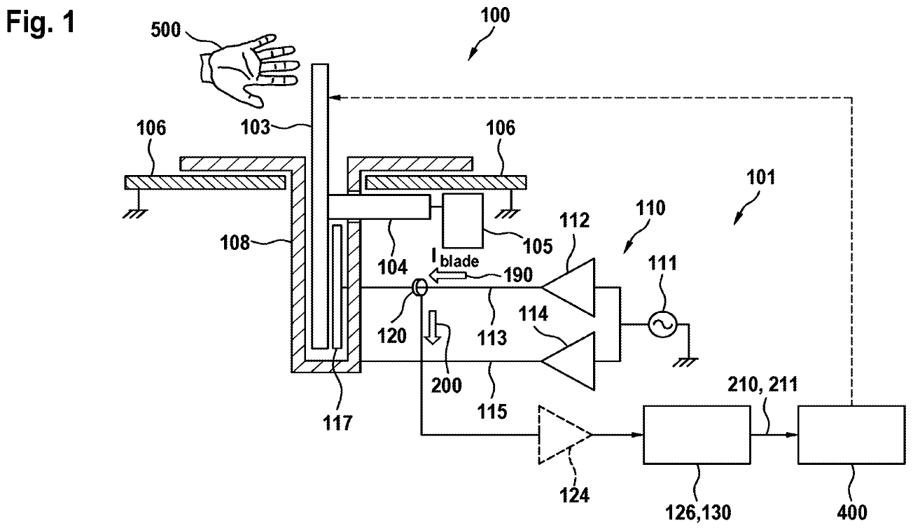

FIG. 1 shows a machine tool designed as a table saw with a detection system for detecting contact between a saw blade and a user;

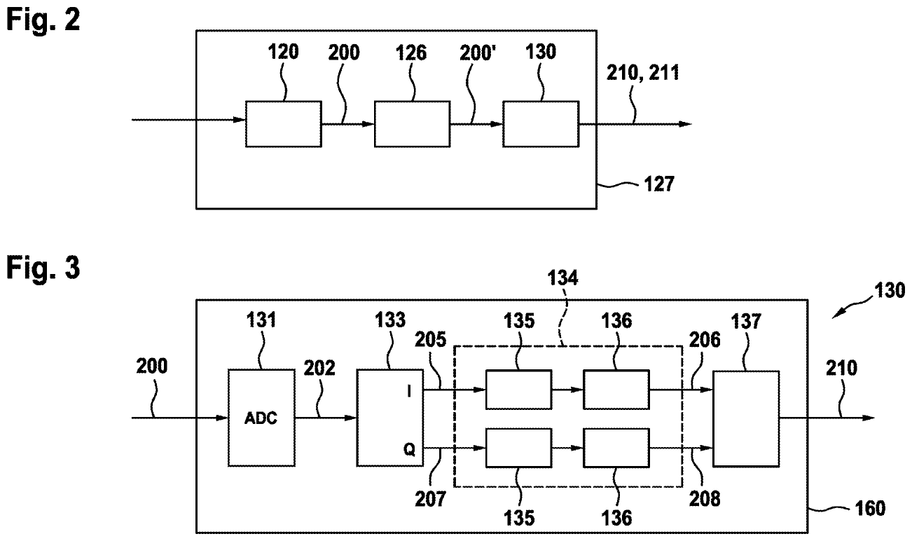

FIG. 2 shows a printed circuit board with components of the detection system;

FIG. 3 shows a processing device of the detection system with an analog-to-digital converter, an IQ demodulator, a filter device and an evaluation device;

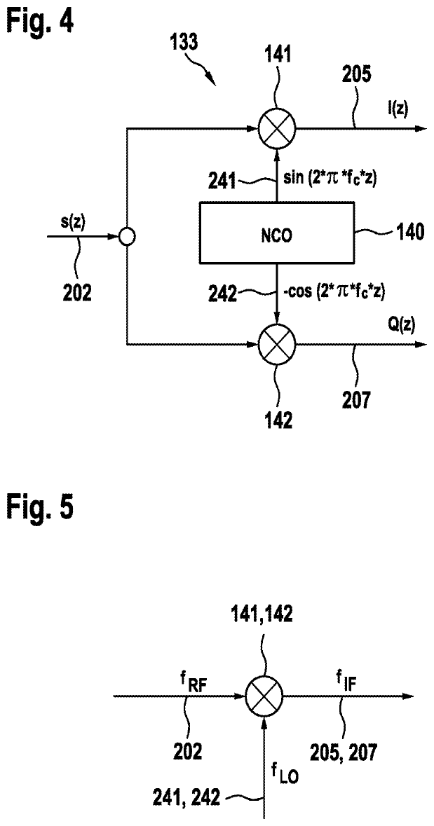

FIGS. 4 and 5 show block diagrams of the IQ demodulator and a mixer;

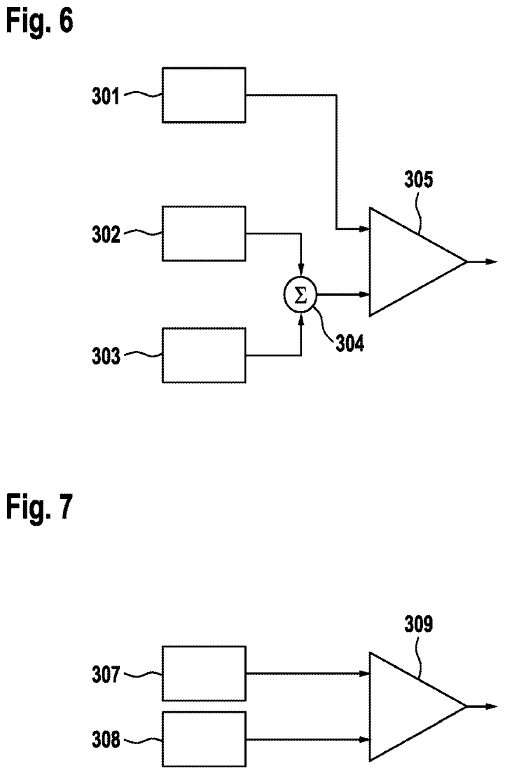

FIGS. 6 and 7 show diagrams illustrating a processing performed by the evaluation device using a predetermined algorithm;

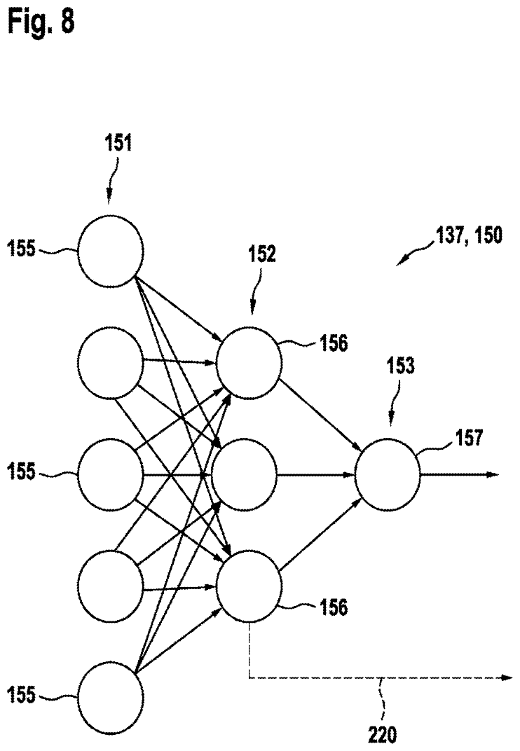

FIG. 8 shows an evaluation device having an artificial neural network;

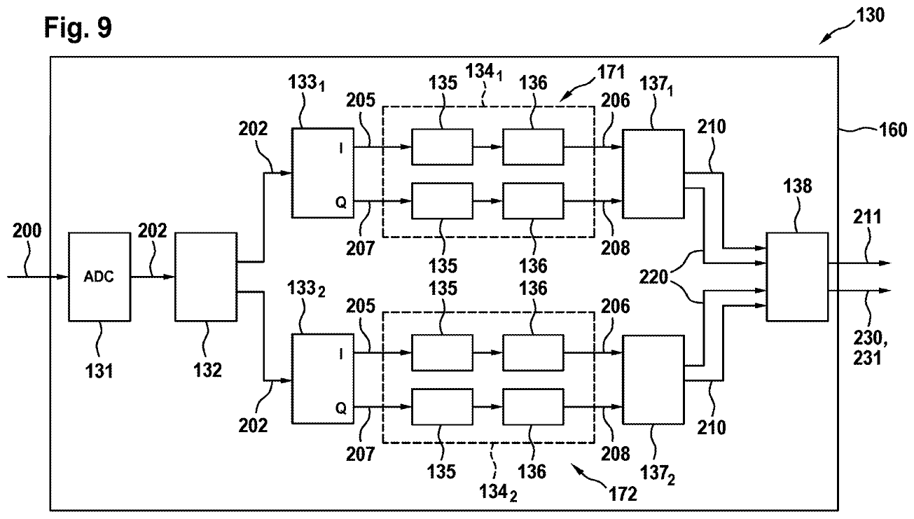

FIG. 9 shows a two-channel design of the processing device;

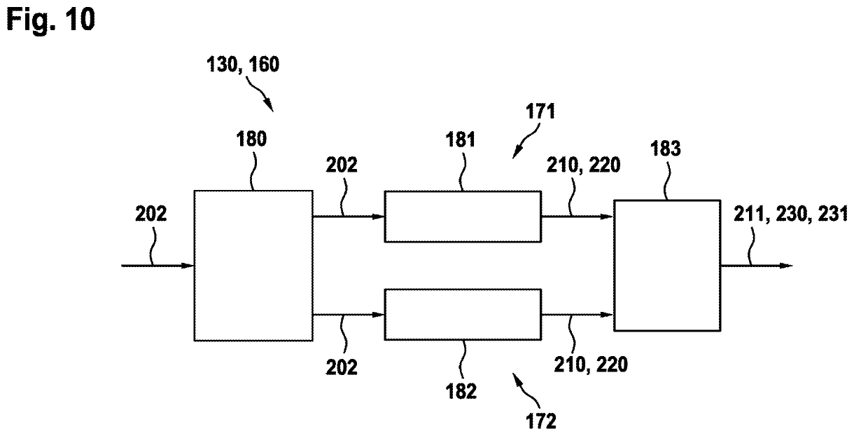

FIG. 10 shows isolated regions of the processing device of FIG. 9, in the form of an FPGA; and

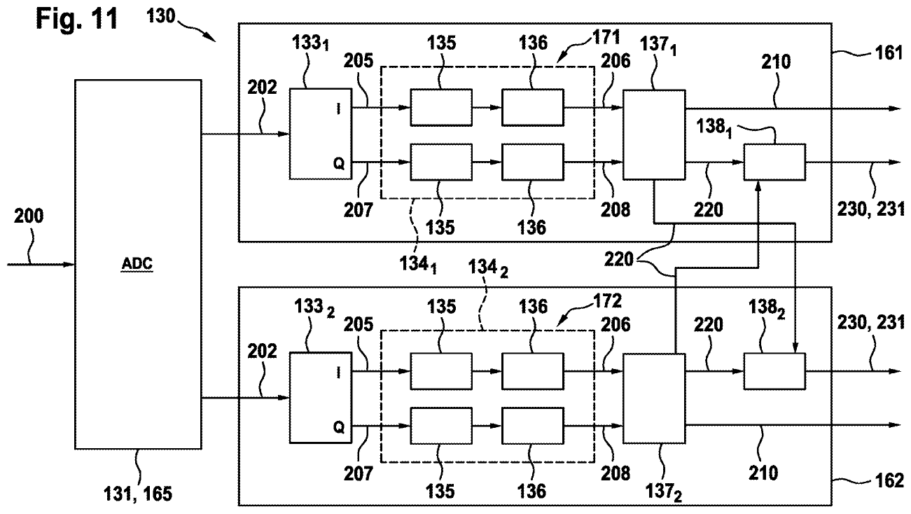

FIG. 11 shows a two-channel design of the processing device with a plurality of semiconductor chips.

Based on the following figures, possible embodiments of a machine tool having a detection system are described. The figures are merely schematic and are not true to scale. Therefore, components and structures shown in the figures may be exaggeratedly large or reduced in size for better understanding.

FIG. 1 shows a machine tool 100, in the present case in the form of a table circular saw. The machine tool 100 has a driveable tool in the form of a rotatable saw blade 103, with which a workpiece made of wood (not shown) can be machined. The saw blade 103 has an electrically conductive or metallic material. The saw blade 103 is connected to a drive shaft 104, which in turn is operatively connected to a motor 105 of the machine tool 100. The motor 105 can be an electric motor. The saw blade 103 can be driven, i.e. set into a rotational movement, via the motor 105 and the drive shaft 104. The machine tool 100 further includes a table 106 having a through-opening through which the saw blade 103 protrudes, thereby standing out relative to an upper surface of the table 106, as shown in FIG. 1.

The machine tool 100 is designed to minimize, to the greatest possible extent, the risk of (serious) injury to a human user during operation of the machine tool 100. For this purpose, the machine tool 100 comprises a detection system 101, using which contact between the saw blade 103 and the user, or a body part of the user such as a hand 500 indicated in FIG. 1, can be detected, and a reaction system 400 coupled to the detection system 101 for deactivating operation of the saw blade 103.

As shown in FIG. 1, the detection system 101 comprises an excitation device 110 for applying an excitation voltage signal to the saw blade 103 by capacitive coupling, a current sensor 120 for generating an analog current sensor signal 200 and a processing device 130 for processing the current sensor signal 200. The application of the excitation voltage signal to the saw blade 103 and the generation and processing of the current sensor signal 200 can take place continuously during the operation of the machine tool 100 and the detection system 101. An analog pre-filter 126 (cf. FIG. 2) can be arranged upstream of the processing device 130.

The excitation device 110 comprises an oscillator 111, a first voltage amplifier 112 connected to the oscillator 111 and driven by it, and an excitation electrode 117 arranged in the region of or near the saw blade 103. The excitation electrode 117, which, like the saw blade 103, is plate-shaped and can also be referred to as an excitation plate, has an electrically conductive or metallic material. The excitation electrode 117 and the first voltage amplifier 112 are electrically connected via a first line 113. Using the oscillator 111, the excitation voltage signal can be generated, amplified via the first voltage amplifier 112 and coupled capacitively into the saw blade 103 via the excitation electrode 117. As indicated in FIG. 1, the table 106 can serve as a (local) ground to which the oscillator 111 can be referenced.

The excitation voltage signal, which is used as carrier signal, is a periodic or sinusoidal voltage signal. In FIG. 1, the excitation voltage signal is indicated by an oscillation wave at oscillator 111. The (amplified) excitation voltage signal can have a peak-to-peak voltage of 12 V and a frequency, or carrier frequency, of 1.25 MHz. In this way, contact between the saw blade 103 and the user can be reliably detected and distinguished from another contact, for example between the saw blade 103 and a workpiece.

The current sensor 120 is arranged on the line 113 connecting the excitation electrode 117 and the voltage amplifier 112. Using the current sensor 120, the electric current 190 flowing in the line 113 and thus consumed by the saw blade 103 (also designated Iblade in FIG. 1) can be acquired. Here, the analog current sensor signal 200 generated by the current sensor 120 represents the current 190 drawn by the saw blade 103. The current sensor 120 can be in the form of a current transformer.

The saw blade 103 and the excitation electrode 117 together form a plate capacitor. For reliable detection, the capacitor can have a capacitance in the range of 30 pF. For this purpose, the distance between the saw blade 103 and the excitation electrode 117 can be in the range of 1 mm. The detection of contact between the saw blade 103 and the user can be based on the capacitance between the saw blade 103 and the excitation electrode 117 is greater than the capacitance between the body of the user and the saw blade 103. In the event that there is no contact between the saw blade 103 and the user, the electric current 190 consumed by the saw blade 103, and thus the current sensor signal 200, can be relatively small or near zero. On the other hand, if the user or a body part thereof contacts the saw blade 103, this can appear as a low resistance connected in series with a larger capacitance to ground. Here, there can be a significant increase in the current draw of the saw blade 103 and thus in the current sensor signal 200, whereby contact between the saw blade 103 and the user can be detected.

As shown in FIG. 1, the machine tool 100 further comprises a shield 108 arranged in the region of the saw blade 103 and the excitation electrode 117. During operation of the machine tool 100, the shield 108 is subjected to the excitation voltage signal corresponding to the excitation electrode 117. For this purpose, the oscillator 111 is connected to a second voltage amplifier 114, which is connected to the shield 108 via a second line 115. Due to the shield 108 surrounding the saw blade 103 and the excitation electrode 117, the static capacitance between the saw blade 103 and the table 106 can be reduced. Further, the shielding can act as a Faraday cage, which can reduce the influence of interference effects from the environment on the detection system 101.

The processing device 130 of the detection system 101 is used to process the analog current sensor signal 200 generated by the current sensor 120 in order to detect contact between the saw blade 103 and the user. As shown in FIG. 1, the current sensor signal 200 coming from the current sensor 120 can be transmitted to the processing device 130 via an optional third voltage amplifier 124, the aforementioned pre-filter 126 and further lines. The sensor signal 200 can be amplified via the voltage amplifier 124, and pre-filtered via the pre-filter 126.

The reaction system 400, which can be activated by the detection system 101, is used to deactivate operation of the saw blade 103 to prevent the occurrence of (serious) injury to the user. The reaction system 400 can include means for rapidly moving the saw blade 103 away from the user, so that the saw blade is no longer protruding relative to the top of the table 106, as shown in FIG. 1, but is below the top of the table. A pyrotechnic charge can be used here. The reaction system 400 can additionally or alternatively have a braking device for braking and thereby stopping a rotational movement of the saw blade 103 (each not shown). Activation of the reaction system 400 for deactivating the operation of the saw blade 103 is controlled via a trigger signal 210, 211, which can be generated by the processing device 130 on the basis of the processing of the current sensor signal 200, and can be transmitted to the reaction system 400.

In the following, further possible embodiments are described that may be considered for the machine tool 100 and its detection system 101. In addition, reference is made to the possibility of combining several of the described embodiments with one another. Accordingly, features and details mentioned with respect to one embodiment may also be applied in another embodiment.

According to the design shown in FIG. 2, the processing device 130 and the current sensor 120 are arranged on a printed circuit board (PCB) 127 of the machine tool 100. In this respect, the arrangement shown in FIG. 2 can be referred to as a PCBA (printed circuit board assembly). The processing device 130 is preceded by the analog pre-filter 126, which can be used to pre-filter the analog current sensor signal 200 generated by the current sensor 120 (and possibly amplified by the optional voltage amplifier 124 according to FIG. 1). In this way, frequency components of the current sensor signal 200 that are not required for the signal processing or that interfere with it can be removed. The pre-filter 126 can be a low-pass filter. For differentiation, the pre-filtered current sensor signal is marked (only) in FIG. 2 with the reference sign 200′. Further components shown in FIG. 1, such as the oscillator 111 and the voltage amplifiers 112, 114, 124, can also be arranged on the circuit board 127. In an embodiment including the optional voltage amplifier 124, this voltage amplifier can be situated between the current sensor 120 and the pre-filter 126.

FIG. 3 shows a possible embodiment of the processing device 130. The processing device 130 has an analog-to-digital converter (ADC) 131 on the input side, which can be used to sample the analog pre-filtered current sensor signal 200 and convert it into a digital current sensor signal 202. A further component of the processing device 130 is an IQ demodulator 133 arranged downstream of the analog-to-digital converter 131, using which demodulator the digital current sensor signal 202 can be demodulated and converted into a digital I signal 205 (in-phase signal) and a digital Q signal 207 (quadrature signal). The processing device 130 further comprises a filter device 134 arranged downstream of the IQ demodulator 133 for filtering the digital I signal 205 and Q signal 207, and thereby providing a filtered digital I signal 206 and a filtered digital Q signal 208. The filtering of the I signal 205 and of the Q signal 207 is performed separately. An evaluation device 137 of the processing device 130 is arranged downstream of the filter device 134. The evaluation device 137 is designed to further process the filtered digital I signal 206 and Q signal 208 in order to detect contact between the saw blade 103 and the user, and to generate a trigger signal 210 for deactivating operation of the saw blade 103 on the basis of the processing. As explained above, the trigger signal 210 can be transmitted to the reaction system 400 (cf. FIG. 1) for the activation thereof.

The IQ demodulator 133, the filter device 134 and the evaluation device 137 of the processing device 130 are digital or digitally operating components. In this way, a relatively short processing or detection time can be achieved for detecting contact between the saw blade 103 and the user. Furthermore, the signal processing can be subject to low external interferences, and consequently can be relatively reliable. In this way, the machine tool 100 equipped with the detection system 101 can have a high degree of functional safety. The processing device 130 and thus the detection system 101 can furthermore be relatively compact and have a space-saving design. This therefore applies in a corresponding manner to the PCBA design shown in FIG. 2.

As indicated in FIG. 3, the processing device 130 can be in the form of a single semiconductor chip or signal processing chip 160. Depending on the embodiment of the semiconductor chip 160, the devices 133, 134, 137 arranged downstream of the analog-to-digital converter 131 and components thereof may be in the form of hardware or software components or modules. Here the analog-to-digital converter 131 and the further devices 133, 134, 137 are in suitable effective data-communicating connection with each other.

The processing device 130, which is designed as a semiconductor chip 160, can be, for example, in the form of a microcontroller or in the form of a CPU (central processing unit). Here, the devices 133, 134, 137 and the components thereof can be in the form of software modules.

Alternatively, the processing device 130 designed as a semiconductor chip 160 can be in the form of an FPGA (field programmable gate array). Here, the devices 133, 134, 137 and their components may be in the form of programmed hardware or logic blocks, also referred to as intellectual property (IP) blocks or functional blocks. An embodiment of the processing device 130 as an FPGA makes it possible to subsequently reconfigure the operation of the processing device 130 by reprogramming. Reprogramming is conceivable, for example, with respect to the filter device 134 in order to adapt the processing device 130 with respect to changed environmental conditions and disturbing influences. The processing device 130, in the form of an FPGA, can further be designed such that parallel signal processing is possible. This can be considered, for example, with respect to the filter device 134. In this way, a short detection time for detecting contact between the tool and the user can be further promoted.

The analog-to-digital converter 131 of the processing device 130 can be designed to carry out digitization of the current sensor signal 200 (cf. FIG. 3) by oversampling. In this embodiment, the sampling frequency used for sampling can be freely selected. In this way, low demands can also be made on the analog pre-filter 126 (cf. FIG. 2). As a result, the pre-filter 126 can be implemented with a relatively simple design, for example in the form of an anti-aliasing filter. It can be considered for the sampling frequency of the analog-to-digital converter 131 to be four times the carrier frequency of the excitation voltage signal applied to the saw blade 103. Given a carrier frequency of 1.25 MHz, the sampling frequency can thus be 5 MHz. In this way, the demodulation of digital current sensor signal 202 carried out using the IQ demodulator 133 can be simplified. The analog pre-filter 126 can have a cutoff frequency equal to half the sampling frequency of the analog-to-digital converter 131. At a sampling frequency of 5 MHz, the cutoff frequency can thus be 2.5 MHz.

The IQ demodulator 133 of the processing device 130 is used to demodulate the digital current sensor signal 202, converting it into a digital I signal 205 and a digital Q signal 206, as indicated above (see FIG. 3). The I signal 205 can agree with the phase of the carrier frequency or excitation voltage signal, whereas the Q signal 207 is ninety degrees out of phase with the carrier frequency or excitation voltage signal.

FIG. 4 shows a block diagram according to which the IQ demodulator 133 can be designed. The IQ demodulator 133 includes a numerically controlled oscillator 140 (NCO), a first mixer 141 and a second mixer 142. The two mixers 141, 142 are used for signal mixing and frequency conversion. Using the numerically controlled oscillator 140, a digital periodic first oscillator signal 241 and a digital periodic second oscillator signal 242 can be generated, wherein the first oscillator signal 241 is fed to the first mixer 141 and the second oscillator signal 242 is fed to the second mixer 142. Furthermore, the digital current sensor signal 202, also designated s(z) in FIG. 4, coming from the analog-to-digital converter 131 is transmitted to each of the two mixers 141, 142. Using the mixers 141, 142, the current sensor signal 202 is multiplied by the relevant first or second oscillator signal 241, 242. In this way, the I signal 205, also designated I(z) in FIG. 4, is output by the first mixer 141, and the Q signal 207, also designated Q(z) in FIG. 4, is output by the second mixer 142.

Oscillator signals 241, 242 may have the same frequency as the excitation voltage signal, i.e. the carrier frequency. The first oscillator signal 241 used to generate the I signal 205 can further agree with the phase of the excitation voltage signal. The first oscillator signal 241 can therefore be a sinusoidal signal, corresponding to the excitation voltage signal, as is also indicated in FIG. 4 by the term sin(2*TT*f_{c}*z). Here, f_{c} is the carrier frequency of the excitation voltage signal. The second oscillator signal 242 used to generate the Q signal 207, which can be a cosine signal as indicated in FIG. 4 by the term −cos(2*π*f_{c}*z), is, in contrast, ninety degrees out of phase therewith.

The two mixers 141, 142 of the IQ demodulator 133 may be designed to perform down conversion during frequency conversion. By way of explanation, FIG. 5 shows a circuit diagram that can be used for the two mixers 141, 142. Here, the signals present at the two inputs and at the output of the relevant mixer 141, 142, i.e. the current sensor signal 202, the first and second oscillator signals 241, 242, and the I signal 205 and Q signal 207, respectively, are assigned corresponding frequencies, i.e. an input frequency f_{RF} (radio frequency), an oscillator frequency f_{LO} (local oscillator), and an output or intermediate frequency f_{IF} (intermediate frequency). For the downmixing, the following applies:

f_{IF}=f_{LO}−f_{RF} (1)

As indicated above, oscillator signals 241, 242 may have the same frequency as the excitation voltage signal acting as carrier signal, i.e. the carrier frequency. The carrier signal can be contained in the current sensor signal 200 generated by the current sensor 120 (cf. FIG. 1), and thus also in the digital current sensor signal 202. The carrier signal can be removed by the downmixing. An item of useful information of interest, or a useful signal which can be used to detect the contact between the saw blade 103 and the user, can in contrast be retained, and can thereby be contained in the digital I signal 205 and Q signal 207.

The filter device 134 (cf. FIG. 3) used after demodulation of the current sensor signal 202 is used to remove unneeded or interfering frequency components of the digital I signal 205 and Q signal 207. The useful signal contained in the I signal 205 and Q signal 207 can, on the other hand, pass through the filter device 134, and can thereby continue to be contained in the filtered digital I signal 206 and Q signal 208 output by the filter device 134. The filter device 134 can be in the form of a low-pass filter in order to remove high-frequency components of the I signal 205 and Q signal 207. Furthermore, the filter device 134 can be designed to reduce the sampling rate (downsampling) and thus the data rate. This can promote fast performance of further signal processing using the evaluation device 137 arranged downstream of the filter device 134.

As shown in FIG. 3, the filtering of the digital I signal 205 and of the Q signal 207 is performed separately. For reliable effective filtering, the filter device 134 according to the embodiment shown in FIG. 3 has a CIC filter 135 (cascaded integrator comb filter) and a compensation filter 136 arranged downstream of the CIC filter 135 for both the I signal 205 and the Q signal 207. The compensation filters 136 can be FIR filters (finite impulse response filters). The aforementioned sample rate reduction can be implemented by means of the CIC filters 135. The associated compensation filters 136 are used to compensate for a sharp drop in the passband of the CIC filters 135 associated with the sampling rate reduction.

For example, the following parameters may be considered for the filter device 134 and its filters 135, 136. The CIC filters 135 may have a decimation factor of 48 reflecting the amount of sample rate reduction, a differential delay of 2 and five filter stages. The compensation filters 136 may have a passband cutoff frequency of 20 kHz, a stopband cutoff frequency of 30 kHz, a filter order of 36, a passband attenuation of 0.01 dB and a stopband attenuation of −40 dB.

The above-mentioned cutoff frequency of the filter device 134 of 20 kHz can be based on the following criteria. During operation of the machine tool 100, the saw blade 103 (cf. FIG. 1) can be rotated at a speed of, for example, 3650 rpm, and thus approximately 60 revolutions per second. The saw blade 103 can have a maximum number of saw teeth of, for example, 200. To calculate a maximum achievable frequency of the useful signal, the speed of the saw blade 103 (60 revolutions per second) can be multiplied by the maximum sawtooth number (200 saw teeth). This results in a maximum frequency of 12 kHz for the useful signal. With a cutoff frequency of 20 kHz for the filter device 134 or the compensation filter 136, a safety margin can be provided. As a result, contact between the saw blade 103 and the user can be reliably detected even if the operation of the machine tool 100 is at a greater speed of the saw blade 103, differing from the aforementioned speed, and/or the saw blade 103 has a greater number of saw teeth, differing from the aforementioned number of saw teeth.

The evaluation device 137 arranged downstream of the filter device 134 (cf. FIG. 3) is used for further processing of the filtered digital I signal 206 and Q signal 208 in order to detect contact between the saw blade 103 and the user and to generate a trigger signal 210 for deactivating operation of the saw blade 103 on the basis of the processing. The evaluation device 137 can be designed to carry out a predetermined calculation algorithm for signal processing using the I signal 206 and Q signal 208, or sampled values of the I signal 206 and Q signal 208.

FIG. 6 shows a diagram with a possible embodiment of the algorithm that can be carried out by the evaluation device 137. Here, there is a calculation of an instantaneous energy value of the current consumption of the saw blade 103 (calculation block 301), a calculation of an adaptive threshold value (calculation blocks 302, 303 and summation nodes 304), and a comparison of the instantaneous energy value with the adaptive threshold value (comparison unit 305). The trigger signal 210 can be generated on the basis of the comparison.

The instantaneous energy value (instant energy) can be calculated in the calculation block 301 from the sum of squared samples of the I and Q signals 206, 208 as follows:

Instant energy(n)=I(n)²Q(n)² (2)

Here, n refers to the relevant sample value of the I and Q signal 206, 208, and I(n)², q(n)² are the squared values. During operation, a separate instantaneous energy value and an associated adaptive threshold value can be calculated for temporally successive sampling values n. The adaptive threshold (adaptive energy) can be calculated as follows in each case:

Adaptive energy(n)=TotalBiasBlock(n)+PeakDetectorOutput(n) (3)

A calculation of the first term in formula (3) can be performed in the calculation block 302 (cf. FIG. 6) according to

$$TotalBiasBlock ( n ) = \frac{G}{N} {\sum }_{N = 16}^{1} Instant Energy ( n ) + Fixed Bias \qquad ( 4 )$$

The sum term is used to calculate an average value of previous instantaneous energy values, which relates to a relevant previous or last block of samples of the I and Q signals 206, 208 with respect to the instantaneous energy value under consideration. The number N of samples of the block can be sixteen, as indicated in equation (4), thereby allowing the calculation to be efficiently and quickly performed. G is a predetermined normalization factor. Furthermore, a predetermined bias value (fixed bias) is added to the sum term.

A calculation of the second term in formula (3) can be performed in the calculation block 303 (cf. FIG. 6) according to

$$LastPeak = PeakDetectorOutput ( n - 1 ) \qquad ( 5 )$$

$$PeakDetectorOutput ( n ) = \{ \begin{matrix}LastPeak + A , & Instant Energy ( n ) > LastPeak \\ LastPeak - D , & Instant Energy ( n ) \leq Last Peak\end{matrix}$$

Here, an output value (PeakDetectorOutput) taking into account the occurrence of peak values of the instantaneous energy can be calculated. With the term LoadPeak, referring to a peak value, the last value of the term PeakDetectorOutput, i.e. from a previous sample of the I and Q signals 206, 208, is taken into account. If the (relevant) instantaneous energy considered (instant energy) exceeds the term LoadPeak, a value A is added to the term LoadPeak; otherwise a value D is subtracted from it to obtain the term PeakDetectorOutput(n) for the (relevant) adaptive threshold to be calculated.

A summation according to formula (3) is performed in summation node 304 according to FIG. 6 to form the adaptive threshold. The adaptive threshold value is further compared with the associated instantaneous energy value, as is indicated in FIG. 6 on the basis of the comparison unit 305. The presence of contact between the saw blade 103 and the user can be assumed when the relevant instantaneous energy value considered exceeds the associated adaptive threshold value, i.e. if the following applies:

Instant energy(n)>adaptive energy(n) (6)

If the condition indicated in formula (6) is fulfilled or the presence of this condition as a result of a corresponding evaluation by the evaluation device 137 is determined, the trigger signal 210 can be generated by the evaluation device 137 (cf. FIG. 3).

Using the adaptive threshold value, a temporal course or a temporal development of the I and Q signal 206, 208 preceding the relevant instantaneous energy value considered can be taken into account. In this way, the influence of individual sampled values of the I and Q signals 206, 208, which may deviate (considerably) from other or neighboring sampled values, for example due to interference from the environment, can be suppressed. As a result, the detection system 101 can have a high degree of robustness, and the detection of contact between the saw blade 103 and the user can take place with a high degree of reliability. Faulty generation of the trigger signal 210, even though there is no contact between the tool 103 and the user (false positive event), can be suppressed here.

The evaluation device 137 can optionally be designed such that the condition indicated in formula (6) is applied as a primary condition, and that the generation of the trigger signal 210 by the evaluation device 137 is subject to an additional secondary condition. For this purpose, the evaluation device 137 can carry out an additional evaluation according to the diagram shown in FIG. 7. Here, a signal-to-noise ratio present in the relevant case is calculated (calculation block 307), which is compared (comparator 309) with a predetermined fixed limit value (preset block 308).

The signal-to-noise ratio can be calculated in the calculation block 307 from a mean value and a standard deviation of sampled values of the filtered I and Q signal 206, 208. To minimize computation time, the computation can be performed in a distributed manner with local mean values and local variances related to multiple blocks of samples from the I and Q signals 206, 208. With regard to an efficient calculation, the number of samples of a block can here as well also be sixteen. Further, a current block of samples comprising samples causing the primary condition to be satisfied, multiple previous blocks of temporally preceding samples, and a subsequent block of temporally succeeding samples may also be taken into account. The number of the previous blocks can be six, so that a total of eight blocks are taken into account.

The local mean value LM of a block of sampled values can each be calculated as follows:

$$LM = \frac{1}{n} {\sum }_{i = 1}^{n} {x}_{i} \qquad ( 7 )$$

Here, Xj denotes a sample value. With reference to the above-mentioned number of sixteen samples per Block, n=16. The global mean value GM from all local mean values LM can be calculated as follows:

$$GM = \frac{1}{{N}_{i , M}} {\sum }_{i = 1}^{n} {LM}_{i} \qquad ( 8 )$$

Here, NLM denotes the number of local mean values LM, and thus blocks. With regard to the above-mentioned number of eight blocks, NLM=8 and n=8. The local variance LV of a block can be calculated in each case as follows:

$$LV = \frac{1}{n} {\sum }_{i = 1}^{n} {( {x}_{i} - {LM}_{1} )}^{2} \qquad ( 9 )$$

The calculation is done with the local average value LM and the sampled values Xj of the block in question. With reference to sixteen sampling values per block, n=16 again applies.

Calculating the global variance is not the same thing as the formation of the mean from all local variances of the blocks; rather, it requires a correction factor to be added to the local variances. This can be done as follows:

CLV=(GM−LM)²+LV (10)

Here, CLV denotes the corresponding corrected local variance of a block. The correction factor is calculated from the global mean value GM and the local mean value LM of the block in question.

The global variance GV can be calculated based on the corrected local variances CLVj of the blocks as follows:

$$GV = \frac{1}{n} {\sum }_{i = 1}^{n} {CLV}_{i} \qquad ( 11 )$$

With regard to the above-mentioned number of eight blocks, n=8. To form the standard deviation, the square root of the global variance GV is calculated, i.e.

Standard Deviation=\sqrt{GV} (12)

The signal-to-noise ratio can be calculated in the calculation block 307 (cf. FIG. 7) by dividing the global mean value GM by the standard deviation. Furthermore, the signal-to-noise ratio is compared with the predetermined limit value provided by the preset block 308, hereinafter referred to as SNR, as indicated in FIG. 7 by the comparator 309. The secondary condition is met when the calculated signal-to-noise ratio exceeds the limit value SNR, i.e. if the following applies:

$$\frac{GM}{Standard Deviation} > SNR \qquad ( 13 )$$

If the primary condition indicated in formula (6) and the secondary condition indicated in formula (13) are met or the presence of these conditions is determined as a result of a corresponding evaluation by the evaluation device 137, the trigger signal 210 can be generated by the evaluation device 137 (cf. FIG. 3). By taking into account the secondary condition, faulty generation of the trigger signal 210 as a result of a strong noise signal can be suppressed.

Furthermore, an embodiment in the form of a self-learning machine which has an artificial neural network can be considered for the evaluation device 137 of the processing device 130 (cf. FIG. 3). FIG. 8 shows a possible embodiment of the evaluation device 137 with such an artificial neural network 150. The neural network 150 is used to further process the filtered digital I signal 206 and Q signal 208, or samples of the I and Q signal 206, 208, in order to generate, based thereon, a trigger signal 210 for deactivating operation of the saw blade 103.

The artificial neural network 150 is constructed from a plurality of networked nodes. As shown in FIG. 8, the artificial neural network 150 can include an input layer 151, a hidden layer 152 and an output layer 153. The input layer 151 has a plurality of input nodes 155 to which the samples of the I and Q signal 206, 208 can be supplied. Differing from the illustration in FIG. 8, the input layer 151 can comprise, for example, thirty-two input nodes 155. The hidden layer 152 can comprise three nodes 156, as shown in FIG. 8. The output layer 153 can have an output node 157, via which the trigger signal 210 (cf. FIG. 3) can be output.

The mode of functioning of the evaluation device 137 with the artificial neural network 150 during operation of the machine tool 100 and of the detection system 101 can be based on a previously performed training of the neural network 150. During training, supervised learning, reinforcement learning or unsupervised learning can be used. The training can be performed using samples of the I and Q signal 206, 208 with correct trigger signals (true positive events) and incorrect trigger signals (false positive events). The correct trigger signals and the corresponding samples of the I and Q signals 206, 208 may relate to the presence of contact to be detected between the saw blade 103 and the user. In contrast, in the case of the wrong trigger signals and the associated sampled values there is no such contact. As a result of the training, the trigger signal can therefore be generated by the evaluation device 137 only in the event of contact actually taking place between the saw blade 103 and the user, and to this extent a distinction can be made between a true positive and a false positive event.

During operation, the nodes 155, 156, 157 of the artificial neural network 150 may process data or data values in the usual manner. Weight factors and activation functions can be used. In order to enable efficient and fast processing, an embodiment of the artificial neural network 150 in the form of a binary neural network can be considered. In this embodiment, it is possible for the weight factors and activation to have binary values only.

The artificial neural network 150 can be designed with a larger network size, differing from the above description and from FIG. 8. For example, the input layer 151 and the hidden layer 152 may have a greater number of nodes 155, 156. Further, instead of one hidden layer 152, the artificial neural network 150 can have multiple successive hidden layers 152.

In the following, further embodiments are described which can be considered for the detection system 101 or the processing device 130. Matching features along with components that are the same and have the same effect are not described in detail again in the following. For details thereof, reference is made instead to the above description.

FIG. 9 shows a further embodiment of the processing device 130. The processing device 130 has an analog-to-digital converter 131 at the input side in order to sample the analog pre-filtered current sensor signal 200 and convert it into a digital current sensor signal 202. Here as well, the analog-to-digital converter 131 and the further devices of the processing device 130 are also suitable operatively connected to one another in terms of data communication. The processing device 130 is designed to process the digital current sensor signal 202 via a first digital processing channel 171 and a second digital processing channel 172. For this purpose, the processing device 130 has a data distributor 132 (data splitter) arranged downstream of the analog-to-digital converter 131, which distributor is used to split the digital current sensor signal 202 and to distribute it to the two processing channels 171, 172.

The processing device 130 has an IQ demodulator 133, a filter device 134 and an evaluation device 137 with respect to each of the two processing channels 171, 172. The devices 133, 134, 137, along with the analog-to-digital converter 131, can be designed as described above. The affiliation to the processing channels 171, 172 is indicated in FIG. 9 by the subscripts 1 and 2. Devices 133₁, 134₁, 137₁ are associated with first processing channel 171, and devices 133₂, 134₂, 137₂ are associated with second processing channel 172. IQ demodulators 133₁, 133₂, arranged downstream of the data distributor 132, receive the digital current sensor signal 202 coming from the data distributor 132, allowing it to be converted into a digital I signal 205 and a digital Q signal 207, respectively. The filter devices 134₁, 134₂ arranged downstream of the IQ demodulators 133₁, 133₂ are used to filter the digital I signal 205 and Q signal 207, and thereby to provide a filtered digital I signal 206 and a filtered digital Q signal 208. The filter devices 134₁, 134₂ each include a CIC filter 135 and a downstream compensation filter 136 for the I signal 205 and the Q signal 207, respectively. The evaluation devices 137₁, 137₂, which are arranged downstream of the filter devices 134₁, 134₂, are designed for further processing of the filtered digital I signal 206 and Q signal 208.

The processing device 130 shown in FIG. 9 further comprises a comparison device 138 arranged downstream of the evaluation devices 137₁, 137₂, to which digital processing data 220 accumulated in the first and second processing channels 171, 172 can be transmitted. The comparison device 138 is, like the other devices 132, 133₁, 133₂, 134₁, 134₂, 137₁, 137₂ arranged downstream of the analog-to-digital converter 131, a digitally operating component. The comparison device 138 is designed to compare the processing data 220 of the first and second processing channels 171, 172 and, on the basis of the comparison, to generate a switch-off signal 230 for switching off operation of the saw blade 103 and/or a warning signal 231. The transmission of the processing data 220 to the comparison device 138 and the comparison thereof using the comparison device 138 can be carried out continuously during the operation of the machine tool 100 or of the detection system 101. The switch-off signal 230 and/or the warning signal 231 can be generated by the comparison device 138, provided there is a difference between the processing data 220 of the two processing channels 171, 172 or such a difference is determined by the comparison device 138. The occurrence of a difference in the processing data 220 of the processing channels 171, 172 is a sign of faulty functioning of at least one of the two processing channels 171, 172, which can be identified on the basis of the comparison by the comparison device 138. In this way, a self-test or continuous self-test of the detection system 101 can take place. As a result, the two-channel processing device 130 enables a high degree of functional safety and reliability of the detection system 101 and of the machine tool 100.

The shutdown signal 230 used for self-shutdown can be transmitted, for example, to the motor 105 (cf. FIG. 1) of the machine tool 100 or to a control device (not shown) controlling the motor 105 to shut down the operation of the saw blade 105 and thereby place the machine tool 100 in a safe condition. The warning signal 231 can, for example, be reproduced acoustically or visually or used to control devices such as a loudspeaker or a display device (not shown) of the machine tool 100.

As indicated in FIG. 9, the processing data 220 used for the comparison may be provided by the evaluation devices 137₁, 137₂ of the two processing channels 171, 172 and transmitted to the comparison device 138. The evaluation devices 137₁, 137₂ can be designed, for example, as explained above with reference to FIGS. 6 and 7, i.e. to carry out a detection algorithm for signal processing and to calculate in each case an instantaneous energy value of the current consumption of the saw blade 103 and an adaptive threshold value. In such an embodiment, the processing data 220 transmitted to the comparison device 138 for the purpose of the comparison can be instantaneous energy values calculated by the evaluation devices 137₁, 137₂.

The evaluation devices 137₁, 137₂ of the two processing channels 171, 172 may further be designed according to FIG. 8 and may each comprise an artificial neural network 150. In such an embodiment, the processing data 220 transmitted to the comparison device 138 for comparison can be data which are output by one or more nodes of the relevant network 150, for example from a hidden layer 152. With reference to the artificial neural network 150 shown in FIG. 8, an output of processing data 220 by a node 156 of the hidden layer 152 is indicated by way of example.

In the comparison of the processing data 220, in each case it is possible for only a portion of the bit values of the corresponding data to be compared. It is possible, for example, for the processing data 220 to be in the form of 32-bit numbers, and for the sixteen bits having the lowest bit value (LSB, least significance bit) to be used for the comparison. In this way, the comparison can be performed by the comparison device 138 with a high speed.

In the two-channel processing device 130 of FIG. 9, the evaluation devices 137₁, 137₂ are designed as described above to generate a trigger signal 210 in response to the processing of the I and Q signals 206, 208. As shown in FIG. 9, the trigger signals 210 coming from the evaluation devices 137₁, 137₂ can be transmitted to the comparison device 138. The comparison device 138 can be designed to generate a separate trigger signal 211 for deactivating operation of the saw blade 103, if the comparison device 138 receives a trigger signal 210 from at least one of the two evaluation devices 137₁, 137₂. As explained above, the trigger signal 211 can be transmitted to the reaction system 400 (cf. FIG. 1) for the activation thereof.

In FIG. 9 it is further indicated that the two-channel processing device 130 can also be in the form of a single semiconductor chip or signal processing chip 160. Depending on the embodiment, the devices 132, 133₁, 133₂, 134₁, 134₂, 137₁, 137₂, 138 arranged downstream of the analog-to-digital converter 131 may be in the form of hardware or software components. The processing device 130 can be, for example, in the form of a microcontroller or a CPU. Alternatively, the processing device 130 can be in the form of an FPGA.

Further, with reference to an FPGA embodiment, the design shown in FIG. 10 can also be considered for the dual-channel processing device 130. Here, the processing device 130 is designed according to the so-called IDF methodology (isolation design flow) and has several, i.e. in the present case four, isolated regions 180, 181, 182, 183 on the physical level. The regions 180, 181, 182, 183 may be isolated from each other by an isolation structure (not shown) also referred to as a “fence.” The first isolated region 180 comprises the data distributor 132 shown in FIG. 9. The region 180 can further comprise a data interface for the digital current sensor signal 202 coming from the analog-to-digital converter 131, along with further data processing elements. The second isolated region 181, which relates to the first processing channel 171, includes the devices 133₁, 134₁, 137₁ shown in FIG. 9. The third isolated region 182, which relates to the second processing channel 172, includes the devices 133₂, 134₂, 137₂. The third insulated region 183 comprises the comparison device 138 shown in FIG. 9. As a result of the design according to the IDF methodology, malfunctions can be avoided with a high degree of reliability. In a corresponding manner, a high degree of reliability and safety of the detection system 101 and of the machine tool 100 can be further promoted.

In order to achieve a high degree of reliability and safety, it is also conceivable to construct a two-channel processing device 130 from a plurality of semiconductor chips, as is shown in FIG. 11. In the embodiment shown in FIG. 11, the processing device 130 comprises an analog-to-digital converter 131, which is in the form of a separate first semiconductor chip or ADC chip 165. The analog-to-digital converter 131 can be used to convert the pre-filtered analog current sensor signal 200 into a digital current sensor signal 202 and to distribute it to digital first and second processing channels 171, 172. Apart from this, the analog-to-digital converter 131 can be designed as described above. The processing device 130 has a separate second semiconductor chip 161 with respect to the first processing channel 171 and a separate third semiconductor chip 162 with respect to the second processing channel 172. The two semiconductor chips 161, 162 can each be in the form of a microcontroller, CPU or FPGA, and each comprise an IQ demodulator 133₁ or 133₂, a filter device 134₁ or 134₂ arranged downstream of the IQ demodulator 133₁, 133₂, an evaluation device 137₁ or 137₂ arranged downstream of the filter device 134₁, 134₂ and a comparison device 138₁ or 138₂ arranged downstream of the evaluation device 137₁, 137₂. These devices can each be designed as described above. The IQ demodulators 133₁, 133₂ are used to convert the digital current sensor signal 202 into a digital I and Q signal 205, 206, which can be filtered by the filter devices 134₁, 134₂ and further processed by the evaluation devices 137₁, 137₂. The evaluation devices 137₁, 137₂ are designed to generate a trigger signal 210 on the basis of the signal processing. As explained above, the trigger signal can be transmitted to the reaction system 400 (cf. FIG. 1).

The comparison devices 138₁, 138₂ of the two semiconductor chips 161, 162 are used to compare digital processing data 220, which can be provided by the evaluation devices 137₁, 137₂, accumulated in the two processing channels 171, 172, and to generate a switch-off signal 230 for switching off operation of the saw blade 103 and/or a warning signal 231 on the basis of the comparison, or if there is a difference. According to the above description, the processing data 220 can be instantaneous energy values calculated by the evaluation devices 137₁, 137₂, or data from an artificial neural network 150 of the evaluation devices 137₁, 137₂, depending on the design of the evaluation devices 137₁, 137₂. The transmission of the processing data 220 to the comparison devices 138₁, 138₂ and the comparison thereof can take place continuously during operation of the machine tool 100.

In addition to the embodiments described above and depicted in the figures, further embodiments which can include further modifications and/or combinations of features are conceivable. In this regard, numerical values given above, such as those given for carrier frequency and sampling frequency and for parameters of filter device 134, may be replaced by other numerical values.

With regard to the execution of a detection algorithm, it is possible to apply only the primary condition explained in FIG. 6 and to omit the secondary condition explained in FIG. 7. This is because, due to the construction of the processing device 130 according to which the signal processing takes place in the digital domain, interfering influences such as noise can be largely avoided. Taking into account only the primary condition favors rapid execution of the signal processing.

The machine tool 100 can be not only in the form of a stationary machine tool or table circular saw, but also in the form of a compact hand-held machine tool such as, for example, a hand circular saw (not shown). This is made possible by the above-described aspects, such as a compact and space-saving design of the processing device 130 and thus of the detection system 101, along with a short detection or processing time for detecting contact. In one embodiment as a hand-guided sawing machine, the reaction system 400 can comprise only one braking device. Furthermore, the machine tool can be designed not only in the form of a sawing machine, but also in the form of some other type of machine tool with a driveable tool.

An excitation voltage signal can be applied to a tool or saw blade 103 not only via a capacitively coupled excitation electrode 105, but also in other ways. With reference to FIG. 1, this can be done, for example, via the drive shaft 104 and a sliding contact.

Although the invention has been further illustrated and described in detail by preferred embodiments, the invention is not limited by the disclosed examples and other variations may be derived therefrom by those skilled in the art without departing from the scope of protection of the invention.

1. A machine tool comprising:
a driveable tool; and
a detection system configured to detect contact between the driveable tool and a user, the detection system comprising:
an excitation device configured to apply an excitation voltage signal to the driveable tool,
a current sensor configured to generate a current sensor signal that represents an electric current consumed by the driveable tool; and
a processing device configured to process the current sensor signal to detect the contact between the driveable tool and the user, the processing device having an analog-to-digital converter and further devices arranged downstream of the analog-to-digital converter, the further devices including an IQ demodulator, a filter device, and an evaluation device, the current sensor signal being digitized using the analog-to-digital converter and being processed in digital form using the further devices.

2. The machine tool according to claim 1, wherein at least one of:
the machine tool is a sawing machine;
the excitation device is configured to apply the excitation voltage signal to the driveable tool by capacitive coupling;
the machine tool comprises a reaction system configured to deactivate operation of the driveable tool; and
the IQ demodulator is arranged downstream of the analog-to-digital converter, the filter device is arranged downstream of the IQ demodulator, and the evaluation device is arranged downstream of the filter device;

3. The machine tool according to claim 1, wherein:
the IQ demodulator is configured to convert the digitized current sensor signal into a digital I signal and a digital Q signal;
the filter device is configured to filter the digital I signal and Q signal; and
the evaluation device is configured to process the filtered digital I signal and Q signal to detect the contact between the driveable tool and the user and to generate a trigger signal configured to deactivate operation of the driveable tool based on the processing by the processing device.

4. The machine tool according to claim 1, wherein the filter device comprises a CIC filter and a compensation filter arranged downstream of the CIC filter.

5. The machine tool according to claim 1, wherein one of:
the evaluation device is configured to (i) calculate an instantaneous energy value of a power consumption of the driveable tool and an adaptive threshold value and (ii) generate a trigger signal configured to deactivate operation of the driveable tool based on a comparison between the instantaneous energy value and the adaptive threshold value; and
the evaluation device is configured to (i) calculate an instantaneous energy value of a current consumption of the driveable tool and an adaptive threshold value, (ii) calculate a signal-to-noise ratio, and (iii) generate a trigger signal configured to deactivate operation of the driveable tool based on a comparison between the instantaneous energy value and the adaptive threshold value and based on a comparison of the calculated signal-to-noise ratio with a predetermined limit value.

6. The machine tool according to claim 1, wherein the evaluation device comprises an artificial neural network.

7. The machine tool according to claim 1, wherein the processing device comprises at least one of:
an FPGA;
a microcontroller; and
a CPU.

8. The machine tool according to claim 1, wherein:
the processing device is configured to process the digitized current sensor signal via a first processing channel and a second processing channel;
the processing device has a respective IQ demodulator, a respective filter device and a respective evaluation device with respect to each of the first processing channel and second processing channel;
the processing device comprises at least one comparison device to which processing data accumulated in the first processing channel and second processing channel is transmitted; and
the at least one comparison device is configured to compare the processing data of the first processing channel and second processing channel and generate, based on the comparison, at least one of:
a switch-off signal configured to switch off operation of the driveable tool; and
a warning signal.

9. The machine tool according to claim 8, wherein:
the respective IQ demodulator of each of the first processing channel and second processing channel is configured to convert the digitized current sensor signal into a digital I signal and a digital Q signal;
the respective filter device of each of the first processing channel and second processing channel is configured to filter the digital I signal and Q signal; and
the respective evaluation device of each of the first processing channel and second processing channel is configured to process the filtered digital I signal and Q signal in order to detect the contact between the driveable tool and the user and generate a trigger signal configured to deactivate operation of the driveable tool based on the processing by the processing device.

10. The machine tool according to claim 9, wherein:
the trigger signals generated by the respective evaluation devices of the first processing channel and second processing channel are transmitted to the at least one comparison device; and
the at least one comparison device is configured to generate its own trigger signal configured to deactivate operation of the driveable tool, provided that at least one of the trigger signals is transmitted to the at least one comparison device by at least one of the respective evaluation devices of the first processing channel and second processing channel.

11. A detection system for a machine tool having a driveable tool for detecting contact between the driveable tool and a user, the detection system comprising:
an excitation device configured to apply an excitation voltage signal to the driveable tool,
a current sensor configured to generate a current sensor signal that represents an electric current consumed by the driveable tool; and
a processing device configured to process the current sensor signal to detect the contact between the driveable tool and the user, the processing device having an analog-to-digital converter and further devices arranged downstream of the analog-to-digital converter, the further devices including an IQ demodulator, a filter device and an evaluation device, the current sensor signal being digitized using the analog-to-digital converter and being processed in digital form using the further devices.
